(19) United States
(12) Patent Application Publication
(10) Pub. No.: US 2018/0307640 A1
(43) Pub. Date: Oct. 25, 2018

(54) DATA TRANSFER APPARATUS, DATA TRANSFER METHOD, AND COMPUTER-READABLE MEDIUM

(71) Applicant: MITSUBISHI ELECTRIC CORPORATION, Tokyo (JP)

(72) Inventors: Hirotaka MOTAI, Tokyo (JP); Masahiro DEGUCHI, Tokyo (JP); Akio IDEHARA, Tokyo (JP); Mitsuo SHIMOTANI, Tokyo (JP); Shu MURAYAMA, Tokyo (JP); Tetsuji FUJISAKI, Tokyo (JP)

(73) Assignee: MITSUBISHI ELECTRIC CORPORATION, Tokyo (JP)

(21) Appl. No.: 15/765,454

(22) PCT Filed: Nov. 26, 2015
(86) PCT No.: PCT/JP2015/083156

§ 371 Date: Apr. 2, 2018

(51) Int. Cl. G06F 13/30; G06F 13/16; G06F 13/364

(52) U.S. Cl. CPC G06F 13/30; G06F 13/364; G06F 13/1642

(57) ABSTRACT

A data transfer apparatus (10) performs data transfer between a main storage device (12) and a peripheral device (13) such as a secondary storage device (131). The data transfer apparatus (10) estimates the frequency of occurrence of the data transfer on the basis of information such as processing executed in a processor (11), sets a transfer length shorter as the frequency of occurrence of the data transfer is higher, and instructs data transfer between the main storage device (12) and the peripheral device (13) in accordance with the transfer length being set, the transfer length indicating the amount of data transferred in one execution of the data transfer.

### TECHNICAL FIELD

The present invention relates to a technique for transferring data from an external storage device to a main storage device.

### BACKGROUND ART

Patent Literature 1 describes direct memory access (DMA) transfer. As described in Patent Literature 1, the DMA transfer is used in some cases for transferring data between a main storage device and a secondary storage device. The DMA transfer is a technique for transferring data directly between the main storage device and the secondary storage device without the intervention of a central processing unit (CPU) in accordance with a transfer request from the CPU. The use of the DMA transfer allows the CPU to execute another processing during data transfer.

On the other hand, data transfer through the intervention of the CPU is called programmed IO (PIO). An operating system (OS) sets which of the DMA transfer and the PIO is used at the time of activation of an apparatus, so that the DMA transfer and the PIO are not used in a mixed manner.

The transfer length set in the DMA transfer is fixed within the range corresponding to an apparatus performing transfer. Specifically, the transfer length is the size specified in CACHE_LINE_SIZE when the apparatus is connected by a peripheral component interconnect (PCI) bus. The transfer length is set in a basic input/output system (BIOS) or OS at the time of activation of the apparatus.

While a transaction is being executed in the DMA transfer, the data transfer occupies the bus so that a transaction of another DMA transfer has to wait.

### CITATION LIST

### Patent literature

Patent Literature 1: JP 05-073476 A

### SUMMARY OF INVENTION

### Technical Problem

Setting of the DMA transfer needs to be made every transfer. Thus, as the transfer length in the DMA transfer is longer, the setting is made a fewer number of times to thus be able to reduce the time required for data transfer. As the transfer length in the DMA transfer is longer, however, it takes more time to process one DMA transfer so that another DMA transfer may possibly have to wait for a long time.

It is an object of the present invention to reduce the waiting time while efficiently performing DMA transfer.

### Mesa to Solve the Invention

A data transfer apparatus according to this invention performs data transfer between a main storage device and a peripheral device.

The data transfer apparatus includes:

a request unit to make a request to set a transfer length shorter as a frequency of occurrence of the data transfer is higher, the transfer length indicating an amount of data transferred in one execution of the data transfer; and

a transfer unit to instruct data transfer between the main storage device and the peripheral device in accordance with the transfer length requested by the request unit.

### Advantageous Effects of Invention

According to the present invention, the transfer length is set shorter as the frequency of occurrence of data transfer is higher. Thus, the transfer length is set long to be able to reduce the data transfer time when the frequency of occurrence of data transfer is low and the wait is less likely to occur. On the other hand, the transfer length is set short to be able to reduce the waiting time when the frequency of occurrence of data transfer is high and the wait is more likely to occur.

### BRIEF DESCRIPTION OF DRAWINGS

FIG. 1 is a block diagram of a data transfer apparatus 10 according to a first embodiment.

FIG. 2 is a flowchart illustrating the operation of an OS 20 according to the first embodiment.

FIG. 3 is a flowchart illustrating the operation of an input/output section 30 according to the first embodiment.

FIG. 4 is a diagram illustrating an example of the operation of the data transfer apparatus 10 according to the first embodiment.

FIG. 5 is a block diagram of a data transfer apparatus 10 according to a first modification.

FIG. 6 is a block diagram of a data transfer apparatus 10 according to a second modification.

FIG. 7 is a block diagram of a data transfer apparatus 10 according to a third modification.

FIG. 8 is a block diagram of a data transfer apparatus 10 according to a second embodiment.

FIG. 9 is a flowchart illustrating the operation of an OS 20 according to the second embodiment.

FIG. 10 is a flowchart illustrating the operation of an input/output section 30 according to the second embodiment.

FIG. 11 is a diagram illustrating an example of the operation of the data transfer apparatus 10 according to the second embodiment.

### DESCRIPTION OF EMBODIMENTS

### First Embodiment

Description of Configuration

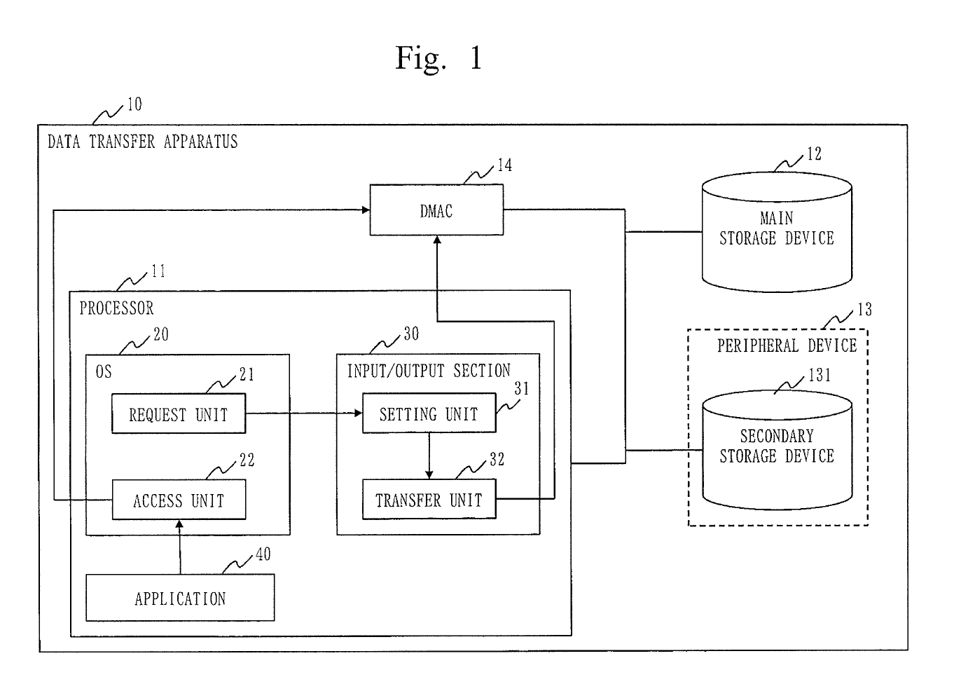

The configuration of a data transfer apparatus 10 according to a first embodiment will be described with reference to FIG. 1.

The data transfer apparatus 10 is a computer.

The data transfer apparatus 10 includes a processor 11, a main storage device 12, a peripheral device 13, and a DMA controller (DMAC) 14. The peripheral device 13 is a secondary storage device 131 in the first embodiment. The peripheral device 13 may also be an audio controller, a display controller, a sensor, an LED display, or an interface of a network such as a Controller Area Network (CAN (registered trademark)). A plurality of the peripheral devices 13 may be provided. The processor 11 is connected to other hardware via a signal line to control these other hardware.

The data transfer apparatus 10 includes an OS 20, an input/output section 30, and an application 40. The OS 20 includes a request unit 21 and an access unit 22 as a functional configuration. The input/output section 30 is software that runs separately from the OS 20, and includes a setting unit 31 and a transfer unit 32 as a functional configuration. The application 40 is software that runs on the OS 20.

The secondary storage device 131 stores a program for implementing the OS 20, the input/output section 30, and the application 40. The program is loaded into the main storage device 12. The program loaded into the main storage device 12 is read by the processor 11 to be executed by the processor 11.

The processor 11 is an integrated circuit (IC) that performs processing. Specifically, the processor 11 is a central processing unit (CPU), a digital signal processor (DSP), or a graphics processing unit (GPU).

The main storage device 12 is specifically a random access memory (RAM).

The secondary storage device 131 is specifically a hard disk drive (HDD). The secondary storage device may also be a portable storage medium such as a secure digital (SD) memory card, a CompactFlash (CF), a NAND flash, a flexible disk, an optical disk, a compact disk, a Blu-ray (registered trademark) disk, or a DVD.

The DMAC 14 is large scale integration (LSI) that performs DMA transfer. Although FIG. 1 illustrates the DMAC 14 independently from the peripheral device 13, the DMAC 14 may be incorporated in the peripheral device 13.

Information, data, a signal value, and a variable value indicating a result of processing of each function implemented by the processor 11 are stored in the main storage device 12 or in a register or cache memory in the processor 11. The following description assumes that the information, the data, the signal value, and the variable value indicating the result of the processing of each function implemented by the processor 11 are stored in the main storage device 12.

Description of Operation

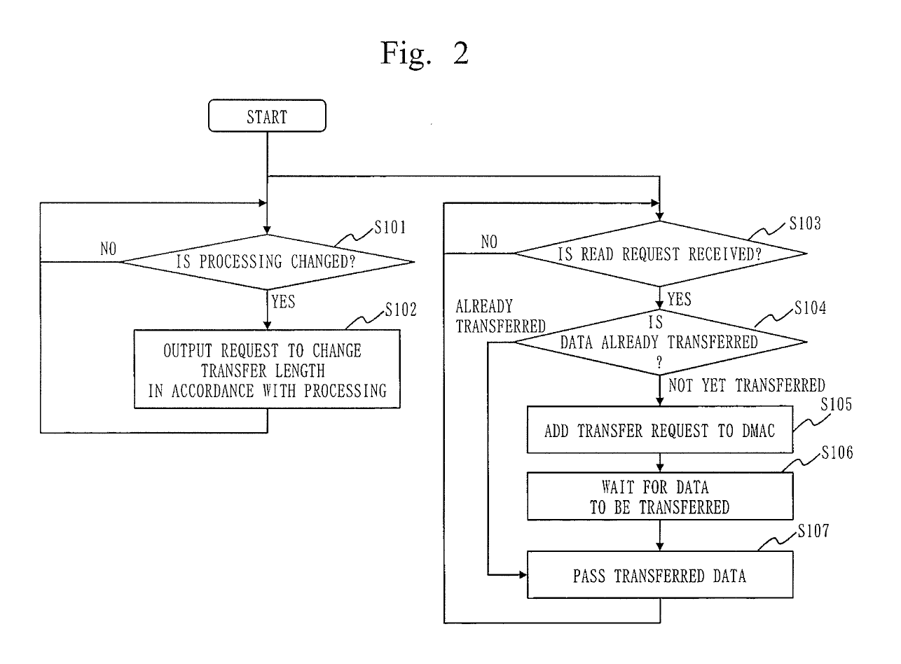

The operation of the data transfer apparatus 10 according to the first embodiment will be described with reference to FIGS. 2 to 4.

The operation of the data transfer apparatus 10 according to the first embodiment corresponds to a data transfer method according to the first embodiment. The operation of the data transfer apparatus 10 according to the first embodiment also corresponds to processing of a data transfer program according to the first embodiment.

In the first embodiment, the data transfer apparatus 10 performs a data transfer by DMA transfer between the main storage device 12 and the secondary storage device 131.

The operation of the OS 20 according to the first embodiment will be described with reference to FIG. 2.

The OS 20 executes processing from step S101 to step S102 concurrently with processing from step S103 to step S107.

In step S101, the request unit 21 determines whether processing performed by the processor 11 is changed.

The request unit 21 advances the processing to step S102 if the processing is changed. If the processing is not changed, on the other hand, step S101 is executed again after the lapse of a predetermined time.

In step S102, the request unit 21 outputs a request to change the transfer length of DMA transfer in accordance with the processing performed by the processor 11. Here, the request unit 21 estimates a frequency of occurrence of data transfer in accordance with the processing performed by the processor 11, and makes a request such that the transfer length indicating the amount of data transferred in one execution of the data transfer is set shorter as the estimated frequency of occurrence of data transfer is higher.

Specifically, when the processing performed by the processor 11 is changed, the request unit 21 estimates the frequency of occurrence of data transfer in accordance with the processing performed by the processor 11. The request unit 21 stores in advance the number of expected occurrences of data transfer per unit time for each program executed by the processor 11, and can thus estimate the frequency of occurrence of data transfer by adding up the number of expected occurrences stored in association with the program executed by the processor 11. The request unit 21 determines the transfer length such that the transfer length indicating the amount of data transferred in one execution of the data transfer is shorter as the frequency of occurrence of data transfer is higher. Then, the request unit 21 writes the determined transfer length into the main storage device 12 and sets a change request flag in the main storage device 12 to “1”.

In step S103, the access unit 22 waits to receive a read request for data issued from internal processing of the application 40 or the OS 20.

The access unit 22 advances the processing to step S104 if the read request is received, or executes step S103 again after the lapse of a predetermined time if the read request is not received.

In step S104, the access unit 22 determines whether or not the data requested by the read request received in step S102 is already transferred from the secondary storage device 131 to the main storage device 12. Specifically, the access unit 22 holds an index of the data already transferred from the secondary storage device 131 to the main storage device 12 and determines whether or not the data is already transferred by searching for the data requested from the index.

The access unit 22 advances the processing to step S105 if the data is not yet transferred, or advances the processing to step S107 if the data is already transferred.

In step S105, the access unit 22 adds a transfer request to the DMAC 14 such that the data requested by the read request is transferred in the next DMA transfer. Specifically, the access unit 22 writes the transfer request at the head of an execution order in the DMAC 14. Note that the access unit 22 writes the transfer request at the head of a command chain, in which a plurality of transfer requests is collectively described as one command, when the command chain is set in the DMAC 14.

The access unit 22 writes, as the transfer request, a transfer source address indicating the address of the secondary storage device 131 as a transfer source, a transfer destination address indicating the address of the main storage device 12 as a transfer destination, and the transfer length. The transfer length in this case may be the transfer length determined in step S102, or may be determined independently of the transfer length determined in step S102. Specifically, in order for the transfer request to be processed efficiently, the transfer length may be increased regardless of the transfer length determined in step S102.

In step S106, the access unit 22 waits for the data requested by the transfer request added in step S105 to be transferred to the main storage device 12. Specifically, the access unit 22 confirms that the data is transferred to the main storage device 12 by accepting an interrupt indicating completion of the DMA transfer from the DMAC 14 or checking the DMAC 14 on a regular basis by means such as polling.

The access unit 22 causes the processor 11 to execute another processing until it is confirmed that the data is transferred to the main storage device 12.

In step S107, the access unit 22 passes the transferred data to a requestor of the read request received in step S103. Specifically, the access unit 22 reads the data in the main storage device 12 and passes the data to the requestor by inter-process communication.

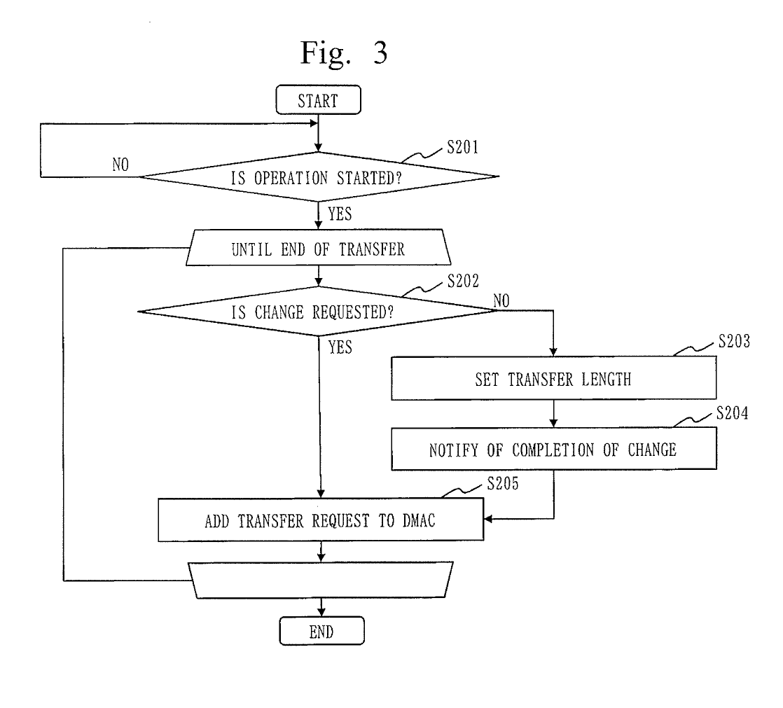

The operation of the input/output section 30 according to the first embodiment will be described with reference to FIG. 3.

In step S201, the transfer unit 32 determines whether or not the operation is started. In the first embodiment, the transfer unit 32 determines that the operation is started when activation of the data transfer apparatus 10 is started. Note that the transfer unit 32 may also determine that the operation is started when initialization of the OS 20 is started, activation of the application 40 is started, the application 40 starts displaying data such as a map, or the processor 11 starts processing upon receiving input from outside.

The transfer unit 32 advances the processing to step S202 if the operation is started, or executes step S201 again after the lapse of a predetermined time if the operation is not started.

Subsequently, the input/output section 30 repeatedly executes the processing from step S202 to step S205 until transfer of data within the transfer range in the secondary storage device 131 is completed.

In step S202, the setting unit 31 determines whether or not a change request is output from the request unit 21 in step S102. Specifically, the setting unit 31 determines that the change request is output when the change request flag in the main storage device 12 is set to “1”.

The setting unit 31 advances the processing to step S203 if the change request is output, or advances the processing to step S205 if the change request is not output.

In step S203, the setting unit 31 sets the transfer unit 32 to use the transfer length included in the change request. Specifically, the setting unit 31 reads the transfer length from the main storage device 12 and writes the transfer length being read into a transfer length variable in the main storage device 12.

In step S204, the setting unit 31 sets the change request flag in the main storage device 12 to “0”. This notifies the request unit 21 in the OS 20 that the change requested in the change request is completed.

In step S205, the transfer unit 32 gives an instruction to perform data transfer between the main storage device 12 and the secondary storage device 131, which is the peripheral device 13, in accordance with the transfer length set to the transfer length variable. Specifically, the transfer unit 32 writes a transfer request to the DMAC 14, the transfer request including a transfer source address being an address at the head of a range that is not yet transferred within the transfer range, a transfer destination address being an address of the main storage device 12 as a transfer destination, and the transfer length being the value set to the transfer length variable.

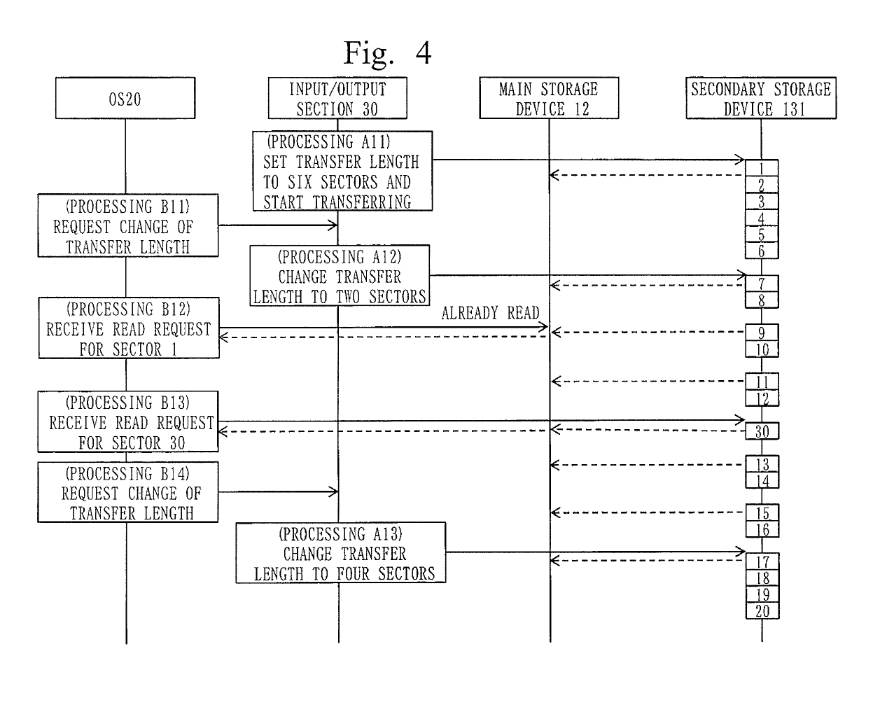

An example of the operation of the data transfer apparatus 10 according to the first embodiment will be described with reference to FIG. 4.

FIG. 4 illustrates the operation of the data transfer apparatus 10 at the time of activation thereof. In FIG. 4, a solid arrow indicates the flow of a request, and a broken arrow indicates the flow of data. Here, it is assumed that data transfer is performed sector by sector.

In processing A11, the transfer unit 32 determines that the operation is started when the activation of the data transfer apparatus 10 is started (step S201), and DMA transfer is performed by writing a transfer request to the DMAC 14 (step S205). Here, it is assumed that an initial value of the transfer length is six (sectors). That is, it is assumed that six (sectors) is set as the initial value in the transfer length variable. As a result, sectors 1 to 6 of the secondary storage device 131 are transferred to the main storage device 12.

Next in processing B11, with the initialization of the OS 20 being completed, the request unit 21 outputs a change request for changing the transfer length to two sectors before activation of the application 40 (step S102). That is, the request unit 21 estimates that the frequency of occurrence of data transfer is higher after the initialization of the OS 20 than during the initialization of the OS 20, thereby making a request to change the transfer length to two sectors shorter than six sectors.

Then, in processing A12, the setting unit 31 sets two sectors to the transfer length variable in response to the change request (steps S202 to S204). The transfer unit 32 thus performs DMA transfer in accordance with the transfer length variable being changed (step S205). As a result, sectors 7 and 8 of the secondary storage device 131 are transferred to the main storage device 12.

Next, in processing B12, the access unit 22 receives a read request from the application 40 to read sector 1 of the secondary storage device 131 (step S103). Here, since sector 1 is already transferred (step S104), the access unit 22 passes data of sector 1 to the application 40 (step S107).

During that time, it is assumed that the transfer unit 32 performs two DMA transfers to transfer sectors 9 and 10 and sectors 11 and 12 of the secondary storage device 131 to the main storage device 12.

Next, in processing B13, the access unit 22 receives a read request from the application 40 to read sector 30 of the secondary storage device 131 (step S103). Here, since sector 30 is not yet transferred (step S104), the access unit 22 adds a transfer request to the DMAC 14 such that sector 30 is transferred in the next DMA transfer. As a result, sector 30 of the secondary storage device 131 is transferred to the main storage device 12.

It is thereafter assumed that the transfer unit 32 performs two DMA transfers to transfer sectors 13 and 14 and sectors 15 and 16 of the secondary storage device 131 to the main storage device 12.

Next in processing B14, with the activation of the application 40 being completed, the request unit 21 outputs a change request for changing the transfer length to four sectors (step S102). That is, the request unit 21 estimates that the frequency of occurrence of data transfer is lower after the activation of the application 40 than during the activation of the application 40, thereby making a request to change the transfer length to four sectors longer than two sectors.

Then, in processing A13, the setting unit 31 sets four sectors to the transfer length variable in response to the change request (steps S202 to S204). The transfer unit 32 thus performs DMA transfer in accordance with the transfer length variable being changed (step S205). As a result, sectors 17 to 20 of the secondary storage device 131 are transferred to the main storage device 12.

The transfer unit 32 thereafter repeats DMA transfers to transfer sectors 21 to 40 of the secondary storage device 131 to the main storage device 12.

Effects of First Embodiment

As described above, the data transfer apparatus 10 according to the first embodiment sets the transfer length shorter as the frequency of occurrence of data transfer is higher. Thus, the transfer length is set long to be able to reduce the data transfer time when the frequency of occurrence of data transfer is low and the wait is less likely to occur. On the other hand, the transfer length is set short to be able to reduce the waiting time when the frequency of occurrence of data transfer is high and the wait is more likely to occur.

According to the data transfer apparatus 10 of the first embodiment, when the operation is started, the transfer unit 32 transfers specific data specified in advance, from the secondary storage device 131 being the peripheral device 13 to the main storage device 12. Therefore, data expected to be requested from the OS 20 and the application 40 can be transferred to the main storage device 12 before the data is requested from the OS 20 and the application 40.

In the first embodiment, it is determined that the operation is started, when the activation of the data transfer apparatus 10 is started. That is, at the time of the activation, the data transfer apparatus 10 according to the first embodiment transfers specific data specified in advance from the secondary storage device 131 being the peripheral device 13 to the main storage device 12. Therefore, data expected to be requested from the OS 20 and the application 40 can be transferred to the main storage device 12 before the data is requested from the OS 20 and the application 40 after the activation of the data transfer apparatus 10.

As described with reference to FIG. 4, at the time of the activation of the data transfer apparatus 10, the request unit 21 estimates that the frequency of occurrence of data transfer is higher after the initialization of the OS 20 in the data transfer apparatus 10 than during the initialization of the OS 20, thereby making a request to reduce the transfer length. The request unit 21 further estimates that the frequency of occurrence of data transfer is lower after the activation of the application 40 than during the activation of the application 40, thereby making a request to increase the transfer length. As a result, the data expected to be requested from the OS 20 and the application 40 can be transferred to the main storage device 12 in a short time while reducing the waiting time at the time of activation of the OS 20 and the application 40.

A vehicle-mounted device such as a car navigation system is equipped with a plurality of functions such as a navigation function and an audio function. Programs and data necessary for executing each function are stored in a non-volatile secondary storage device such as an HDD, and are loaded to a main storage device at the time of activation of the system to be executed by a processor.

Applying the data transfer apparatus 10 of the first embodiment to the vehicle-mounted device can reduce the data transfer time from the secondary storage device to the main storage device while reducing the waiting time to not interfere with the activation processing. The vehicle-mounted device can thus reduce the time required to provide service.

In the vehicle-mounted device, information indicating the state of the system such as a travel history and a history of audio reproduction is transferred from the main storage device to the secondary storage device by the processor as appropriate and stored therein. These pieces of information are used to restore a previous state at the time of activation of the system. These pieces of information are also used when a user sets a destination frequented by the user or plays his favorite music.

Applying the data transfer apparatus 10 of the first embodiment to the vehicle-mounted device can reduce the data transfer time from the main storage device to the secondary storage device while reducing the waiting time to not interfere with the processing performed to provide service to a user. As a result, the data important for providing service can be reliably stored while reducing or preventing an impact on the user.

Note that the above description describes the case where data is transferred from the secondary storage device 131, which is the peripheral device 13, to the main storage device 12. However, the description can also be applied to a case where data is transferred from the main storage device 12 to the peripheral device 13.

In the above description, the change request flag is used to notify the input/output section 30 that the change request is issued. However, instead of using the change request flag, a message queue or register may be used to notify the input/output section 30 that the change request is issued.

Other Configurations

### First Modification

In the first embodiment, the OS 20 and the input/output section 30 are executed by the same processor 11. However, as a first modification, the OS 20 and the input/output section 30 may be executed in parallel by different processors 11. The first modification will be described focusing on differences between the first embodiment and the first modification.

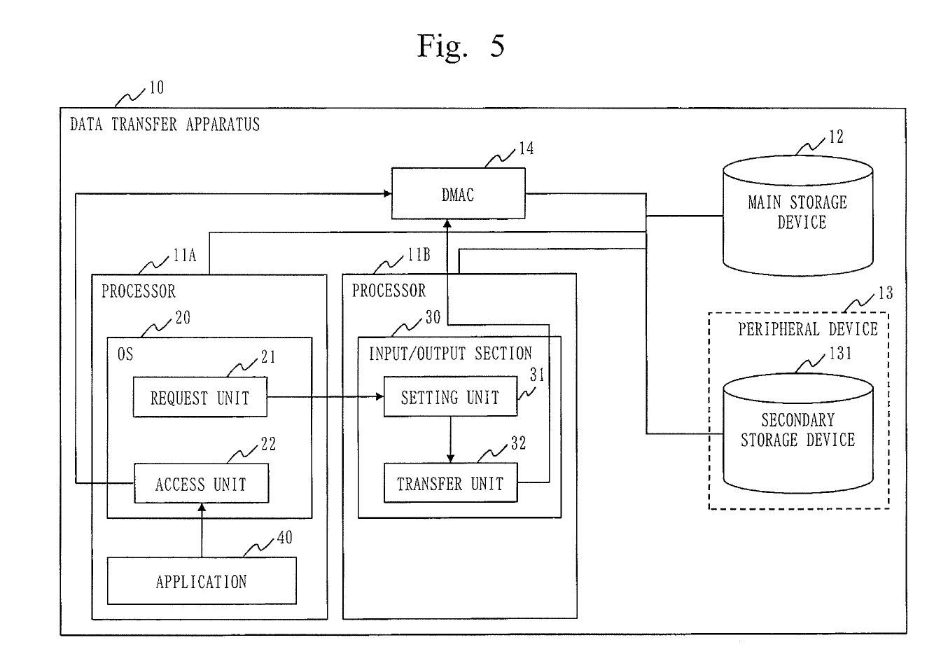

The configuration of a data transfer apparatus 10 according to the first modification will be described with reference to FIG. 5.

The data transfer apparatus 10 includes a processor 11A, a processor 11B, a main storage device 12, a peripheral device 13, and a DMAC 14. An OS 20 is loaded into the processor 11A and executed by the processor 11A. An input/output section 30 is loaded into the processor 11B and executed by the processor 11B.

### Second Modification

In the first embodiment, the input/output section 30 is the software that runs separately from the OS 20. However, as a second modification, the input/output section 30 may be software that runs on the OS 20. The second modification will be described focusing on differences between the first embodiment and the second modification.

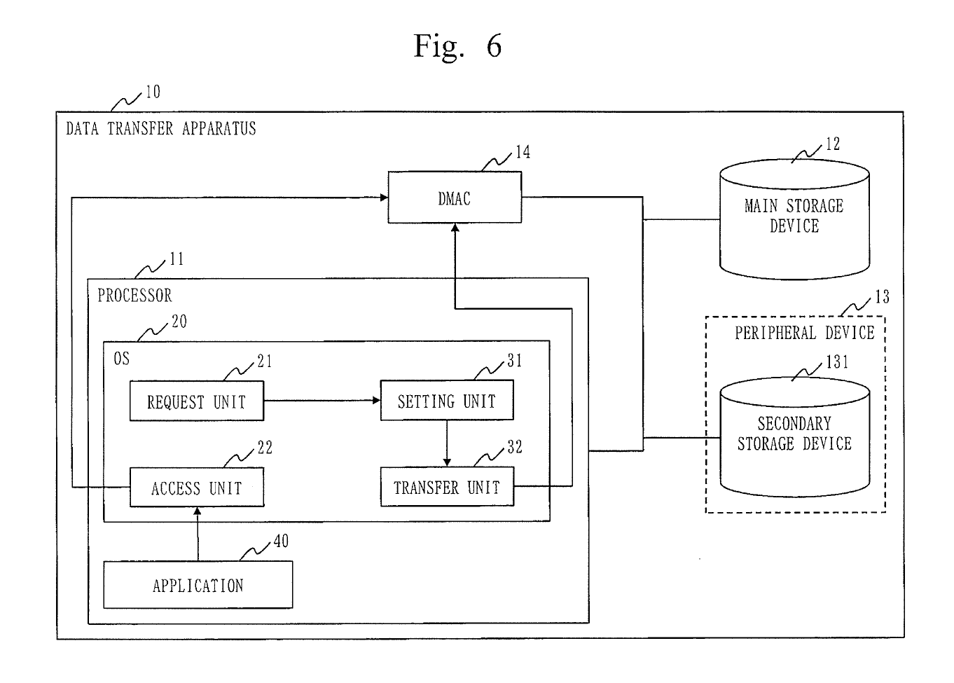

The configuration of a data transfer apparatus 10 according to the second modification will be described with reference to FIG. 6.

The data transfer apparatus 10 includes an OS 20 and an application 40. The OS 20 includes a request unit 21, an access unit 22, a setting unit 31, and a transfer unit 32 as a functional configuration. The setting unit 31 and the transfer unit 32 may be device drivers or user land software. Alternatively, the setting unit and the transfer unit may be software that operates as a thread or a process.

Although the setting unit 31 and the transfer unit 32 are software that operate on the OS 20, the setting unit 31 and the transfer unit 32 can operate when a boot loader is activated. The setting unit 31 and the transfer unit 32 can thus operate even while the OS 20 is being activated. The boot loader is software for performing minimal initialization of the data transfer apparatus 10 and loading the OS 20 into a main storage device 12.

### Third Modification

In the first embodiment, the functions of the request unit 21, the access unit 22, the setting unit 31, and the transfer unit 32 are implemented by software. However, as a third modification, the functions of the request unit 21, the access unit 22, the setting unit 31, and the transfer unit 32 may be implemented by hardware. The third modification will be described focusing on differences between the first embodiment and the third modification.

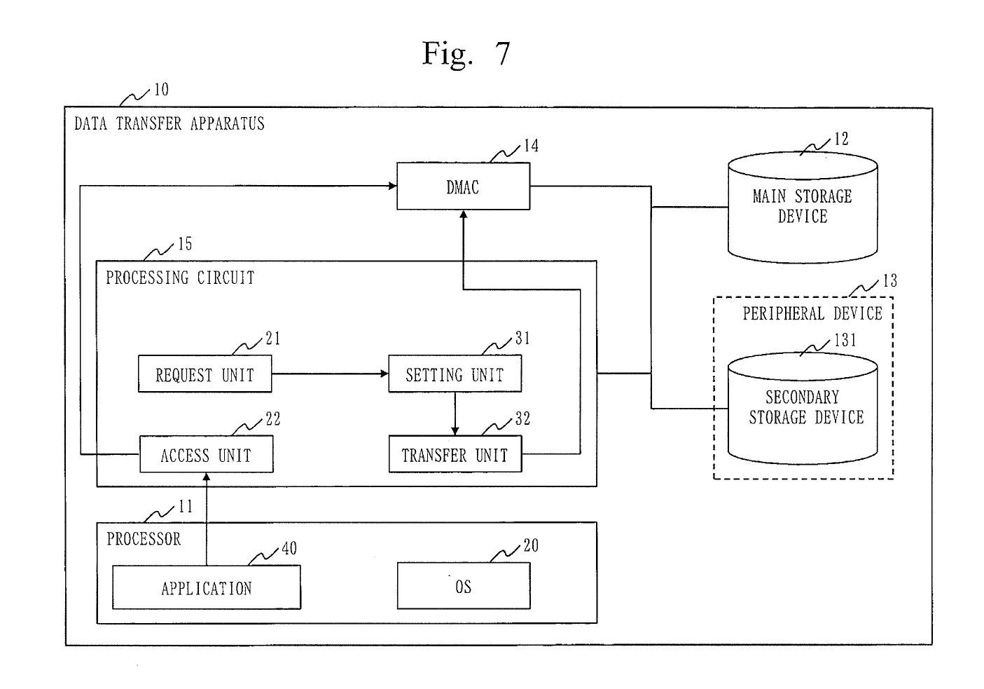

The configuration of a data transfer apparatus 10 according to the third modification will be described with reference to FIG. 7.

When the functions of a request unit 21, an access unit 22, a setting unit 31, and a transfer unit 32 are implemented by hardware, the data transfer apparatus 10 further includes a processing circuit 15. The processing circuit 15 is a dedicated electronic circuit for implementing the functions of the request unit 21, the access unit 22, the setting unit 31, and the transfer unit 32.

The processing circuit 15 can be a single circuit, a composite circuit, a programmed processor, a parallel programmed processor, a logic IC, a gate array (GA), an application specific integrated circuit (ASIC), or a field-programmable gate array (FPGA).

The function of each of the units may be implemented by one processing circuit 15 or may be implemented by a plurality of processing circuits 15 in a distributed manner.

### Fourth Modification

As a fourth modification, some functions may be implemented by hardware while other functions may be implemented by software. That is, the functions of a request unit 21, an access unit 22, a setting unit 31, and a transfer unit 32 may be implemented partly by hardware and the rest by software.

A processor 11, a main storage device 12, and a processing circuit 15 are collectively referred to as “processing circuitry”. That is, the functions of the request unit 21, the access unit 22, the setting unit 31, and the transfer unit 32 are implemented by the processing circuitry. More specifically, the functions of the request unit 21, the access unit 22, the setting unit 31, and the transfer unit 32 are implemented by the processing circuitry regardless of the configuration of the data transfer apparatus 10 illustrated in any of FIGS. 1, 6, and 7.

### Second Embodiment

In the first embodiment, the processing performed by the processor 11 estimates the frequency of occurrence of data transfer to determine the transfer length. A second embodiment is different from the first embodiment in that the frequency of occurrence of data transfer is also estimated by the number of requestors requesting data transfer to determine the transfer length. This difference will be described in the second embodiment.

Description of Configuration

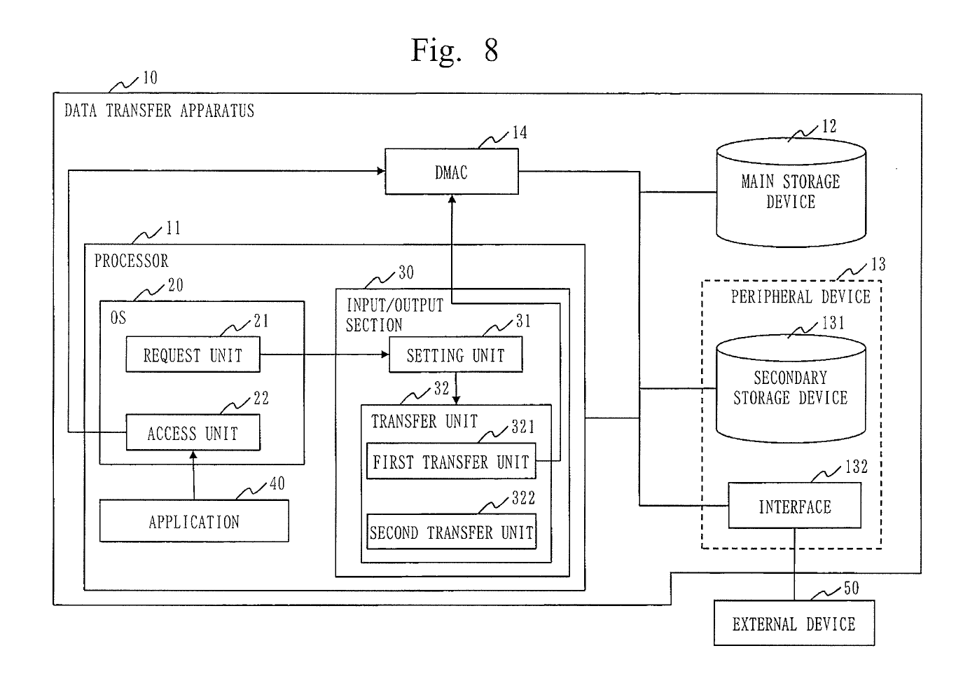

The configuration of a data transfer apparatus 10 according to the second embodiment will be described with reference to FIG. 8.

In the second embodiment, a peripheral device 13 includes a secondary storage device 131 and an interface 132.

The interface 132 is an interface for a network such as Bluetooth (registered trademark), WiFi, or CNA. The interface 132 may be provided for each network or may be shared by a plurality of networks. The data transfer apparatus 10 is connected to an external device 50 via the interface 132.

A transfer unit 32 includes a first transfer unit 321 and a second transfer unit 322 as a functional configuration. The first transfer unit 321 is software for transferring data between a main storage device 12 and the secondary storage device 131, while the second transfer unit 322 is software for transferring data between the main storage device 12 and the interface 132.

Description of Operation

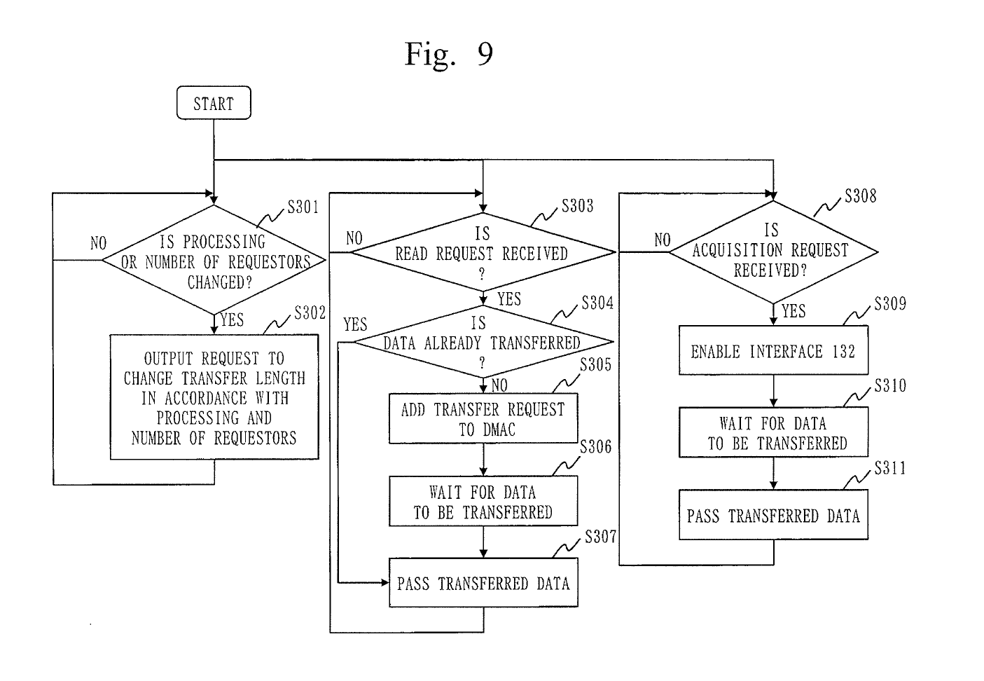

The operation of the data transfer apparatus 10 according to the second embodiment will be described with reference to FIGS. 9 to 11.

The operation of the data transfer apparatus 10 according to the second embodiment corresponds to a data transfer method according to the second embodiment. The operation of the data transfer apparatus 10 according to the second embodiment also corresponds to processing of a data transfer program according to the second embodiment.

In the second embodiment, the data transfer apparatus 10 performs a data transfer by DMA transfer between the main storage device 12 and each of the secondary storage device 131 and the interface 132. Here, it is assumed that the secondary storage device 131 and the interface 132 perform data transfer with the main storage device 12 using the same bus.

The operation of an OS 20 according to the second embodiment will be described with reference to FIG. 9.

The OS 20 executes processing from step S301 to step S302, processing from step S303 to step S307, and processing from step S308 to step S311 concurrently with one another.

In step S301, a request unit 21 determines whether there is a change in at least either the processing performed by a processor 11 or the number of requestors requesting data transfer that uses the same bus.

The request unit 21 advances the processing to step S302 if at least one of them is changed. If neither one of them is changed, on the other hand, step S301 is executed again after the lapse of a predetermined time.

In step S302, the request unit 21 outputs a request to change the transfer length of DMA transfer in accordance with the processing performed by the processor 11 and the number of requestors requesting data transfer that uses the same bus.

Specifically, the request unit 21 estimates the frequency of occurrence of data transfer on the basis of the processing performed by the processor 11 and the number of requestors requesting data transfer that uses the same bus. The request unit 21 determines the transfer length such that the transfer length indicating the amount of data transferred in one execution of the data transfer is shorter as the frequency of occurrence of data transfer is higher. Then, the request unit 21 writes the determined transfer length into the main storage device 12 and sets a change request flag in the main storage device 12 to “1”. Here, the transfer lengths are separately written for the first transfer unit 321 and the second transfer unit 322, and the change request flags are separately set for the first transfer unit 321 and the second transfer unit 322.

The processing from step S303 to step S307 is the same as the processing from step S103 to step S107 in FIG. 2.

In step S308, an access unit 22 waits to receive a data acquisition request from the external device 50 connected via the interface 132, the request being issued from internal processing of an application 40 or the OS 20.

The access unit 22 advances the processing to step S309 if the acquisition request is received, or executes step S308 again after the lapse of a predetermined time if the acquisition request is not received.

In step S309, the access unit 22 enables the interface 132. Specifically, the access unit 22 turns on the power of the interface 132.

In step S310, the access unit 22 waits for data to be transferred from the interface 132 to the main storage device 12. Specifically, the access unit 22 confirms that the data is transferred to the main storage device 12 by accepting an interrupt indicating completion of the DMA transfer from a DMAC 14 or checking the DMAC 14 on a regular basis by means such as polling. The access unit 22 causes the processor 11 to execute another processing until it is confirmed that the data is transferred to the main storage device 12.

In step S311, the access unit 22 passes the transferred data to a requestor of the acquisition request received in step S308. Specifically, the access unit 22 reads the data in the main storage device 12 and passes the data to the requestor by inter-process communication.

Note that the access unit 22 disables the interface 132 after passing the data. Specifically, the access unit 22 turns off the power of the interface 132.

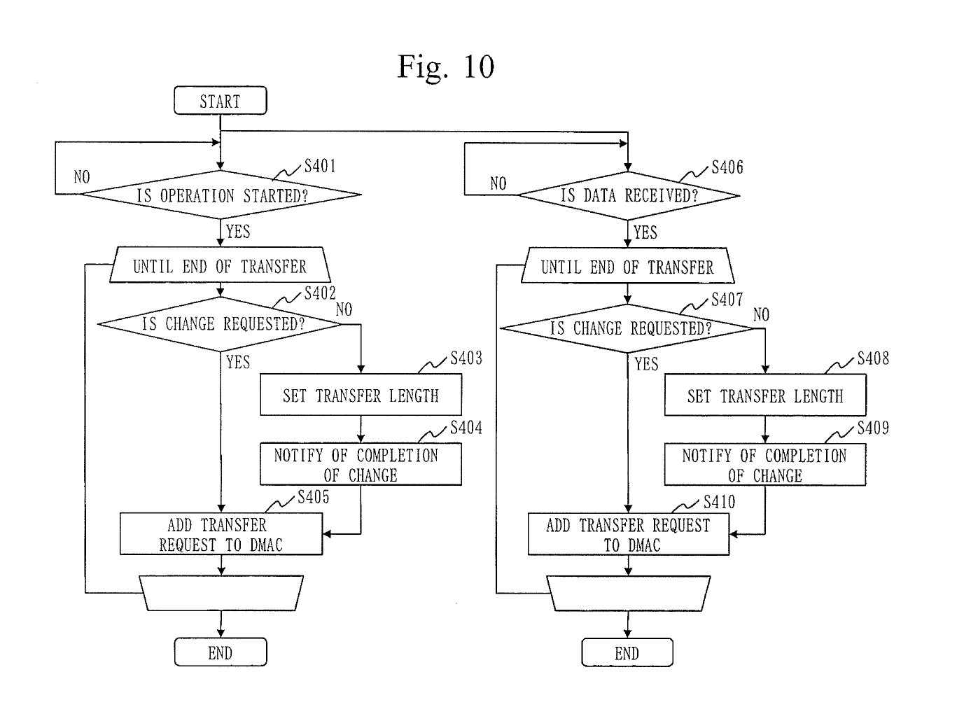

The operation of an input/output section 30 according to the second embodiment will be described with reference to FIG. 10.

The input/output section 30 executes processing from step S401 to step S405 concurrently with processing from step S406 to step S410.

The processing from step S401 to step S405 is the same as the processing from step S201 to step S205 in FIG. 3. Note that the processing from step S401 to step S405 is executed by the first transfer unit 321. Moreover, in step S402 and step S404 the change request flag for the first transfer unit 321 is used, and in step S403 the transfer length for the first transfer unit 321 is used.

In step S406, the second transfer unit 322 determines whether or not data is received from the external device 50 to which the interface 132 is connected.

The second transfer unit 322 advances the processing to step S407 if the data is received, or executes step S406 again after the lapse of a predetermined time if the data is not received.

Subsequently, the input/output section 30 repeatedly executes the processing from step S407 to step S410 until transferring of the received data is completed.

In step S407, a setting unit 31 determines whether or not a change request is output from the request unit 21 in step S302. Specifically, the setting unit 31 determines that the change request is output when the change request flag for the second transfer unit 322 in the main storage device 12 is set to “1”.

The setting unit 31 advances the processing to step S408 if the change request is output, or advances the processing to step S410 if the change request is not output.

In step S408, the setting unit 31 sets the transfer unit 32 to use the transfer length included in the change request. Specifically, the setting unit 31 reads the transfer length for the second transfer unit 322 from the main storage device 12, and writes the transfer length being read into a transfer length variable in the main storage device 12.

In step S409, the setting unit 31 sets the change request flag for the second transfer unit 322 in the main storage device 12 to “0”. This notifies the request unit 21 in the OS 20 that the change requested in the change request is completed.

In step S410, the transfer unit 32 writes a transfer request to the DMAC 14. Specifically, the transfer unit 32 writes a transfer request including a transfer source address being an address at the head of a range that is not yet transferred among the data being received, a transfer destination address being an address of the main storage device 12 as a transfer destination, and the transfer length being the value set to the transfer length variable.

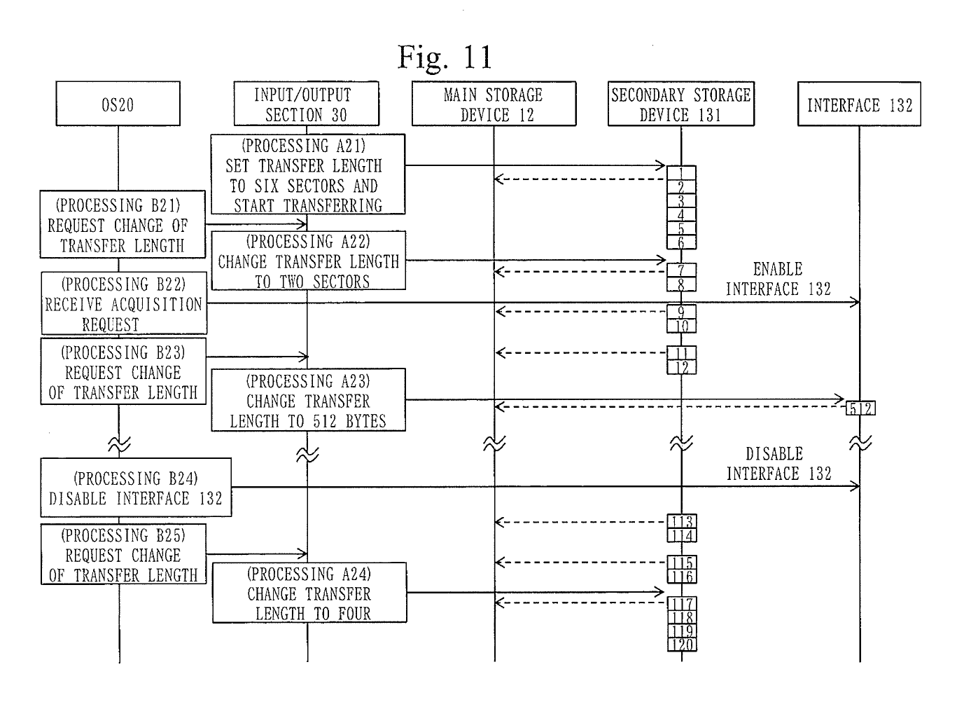

An example of the operation of the data transfer apparatus 10 according to the second embodiment will be described with reference to FIG. 11.

FIG. 11 illustrates the operation of the data transfer apparatus 10 at the time of activation thereof. In FIG. 11, a solid arrow indicates the flow of a request, and a broken arrow indicates the flow of data. Here, data transfer for the secondary storage device 131 is performed sector by sector, while data transfer for the interface 132 is performed byte by byte.

Processings A21, A22, and B21 are similar to processings A11, A12, and B11 illustrated in FIG. 4, and thus will not be described.

In processing B22 following processing A22, the access unit 22 receives an acquisition request from the application 40 to acquire data from the external device 50 connected via the interface 132 (step S308). The access unit 22 then enables the interface 132 (step S309). Here, it is assumed that the transfer length for the second transfer unit 322 is set to 1536 bytes. That is, it is assumed that 1536 bytes is set as the initial value in the transfer length variable for the second transfer unit 322.

During that time, it is assumed that the transfer unit 32 performs two DMA transfers to transfer sectors 9 and 10 and sectors 11 and 12 of the secondary storage device 131 to the main storage device 12.

Next, in processing B23, the request unit 21 outputs a change request for changing the transfer length of the second transfer unit 322 to 512 bytes (step S302). That is, since the number of requestors is increased with the interface 132 added as a requestor requesting data transfer using the same bus, the request unit 21 estimates that the frequency of occurrence of data transfer is high and thus makes a request to change the transfer length to 512 bytes shorter than 1536 bytes.

Then, in processing A23, the setting unit 31 sets 512 bytes as the transfer length variable for the second transfer unit 322 in response to the change request (steps S407 to S409). The second transfer unit 322 thus performs DMA transfer in accordance with the transfer length variable being changed (step S410). As a result, 512 bytes of data is transferred from the interface 132 to the main storage device 12.

Thereafter, DMA transfer is performed by the first transfer unit 321 and the second transfer unit 322 (steps S402 to S405 and steps S407 to S410) so that up to sector 114 in the secondary storage device 131 is transferred to the main storage device 12 and that all the data received by the interface 132 is transferred.

With all the data received by the interface 132 being transferred, the access unit 22 disables the interface 132 in processing B24 (step S410). This can reduce power consumption of the data transfer apparatus 10.

Processings B25 and A24 are similar to processings B14 and A13 illustrated in FIG. 4, and thus will not be described.

Note that in processing B23, the request unit 21 makes a request to reduce the transfer length of only the second transfer unit 322. The request unit 21 may however make a request to reduce not only the transfer length of the second transfer unit 322 but also the transfer length of the first transfer unit 321. Specifically, the request unit 21 may make a request to change the transfer length of the first transfer unit 321 to one sector shorter than two sectors as well as making a request to change the transfer length of the second transfer unit 322 to 512 bytes shorter than 1536 bytes.

Effects of Second Embodiment

As described above, the data transfer apparatus 10 according to the second embodiment determines the transfer length by estimating the frequency of occurrence of data transfer on the basis of not only the processing performed in the processor 11 but also the number of requestors requesting data transfer. Thus, when the external device 50 performing data transfer is connected, the frequency of occurrence of data transfer can be estimated more appropriately to be able to determine the transfer length more appropriately.

Another Configuration

### Fifth Modification

In the second embodiment, the transfer length is reduced as the number of requestors requesting data transfer is increased. However, as a fifth modification, the transfer lengths for some requestors may be increased while reducing the transfer lengths for other requestors. The fifth modification will be described focusing on differences between the second embodiment and the fifth modification.

In the fifth modification, a request unit 21 determines priority for each requestor in advance. It is assumed in the fifth modification that an interface 132 has high priority while the others have low priority.

When the number of requestors requesting data transfer increases, the request unit 21 makes a request to increase the transfer length for a requestor with high priority and reduce the transfer length for a requestor with low priority. In the fifth modification, in processing B23 of FIG. 11, the request unit 21 outputs a change request to change the transfer length for a first transfer unit 321 to one sector shorter than two sectors and change the transfer length for a second transfer unit 322 to 3072 bytes longer than 1536 bytes.

The increase in the transfer length for the requestor having high priority as described above can complete data transfer quickly for the requestor having high priority.

### Sixth Modification

As with the first embodiment, the functions of the request unit 21, the access unit 22, the setting unit 31, and the transfer unit 32 are implemented by software. However, as with the third modification of the first embodiment, the functions of the request unit 21, the access unit 22, the setting unit 31, and the transfer unit 32 may be implemented by hardware. Alternatively, as with the fourth modification of the first embodiment, the functions of the request unit 21, the access unit 22, the setting unit 31, and the transfer unit 32 may be implemented partly by hardware and the rest by software.

### REFERENCE SIGNS LIST

10 data transfer apparatus
11 processor
12 main storage device
13 peripheral device
131 secondary storage device
132 interface
14 DMAC
20 OS
21 request unit
22 access unit
30 input/output section
31 setting unit
32 transfer unit
321 first transfer unit
322 second transfer unit
40 application
50 external device

1-7. (canceled)

8. A data transfer apparatus that performs data transfer between a main storage device and a peripheral device, the data transfer apparatus comprising:
processing circuitry to:
estimate that, at the time of activation of the data transfer apparatus, a frequency of occurrence of the data transfer is higher after initialization of an operating system (OS) of the data transfer apparatus than during the initialization of the OS, and make a request to set a transfer length shorter as the frequency of occurrence of the data transfer is higher, the transfer length indicating an amount of data transferred in one execution of the data transfer; and
instruct data transfer in which specific data is transferred from the peripheral device to the main storage device, at the time of activation of the data transfer apparatus, in accordance with the transfer length requested.

9. The data transfer apparatus according to claim 8, wherein
the processing circuitry estimates the frequency of occurrence of the data transfer by processing performed in a processor.

10. The data transfer apparatus according to claim 8, wherein
the processing circuitry estimates the frequency of occurrence of the data transfer by the number of requestors requesting the data transfer.

11. The data transfer apparatus according to claim 9, wherein
the processing circuitry estimates the frequency of occurrence of the data transfer by the number of requestors requesting the data transfer.

12. The data transfer apparatus according to claim 10, wherein
the processing circuitry makes a request to set the transfer length longer for some of the requestors than for other requestors.

13. A data transfer method that performs data transfer between a main storage device and a peripheral device, the data transfer method comprising:
estimating that, at the time of activation of the data transfer apparatus, a frequency of occurrence of the data transfer is higher after initialization of an operating system (OS) of the data transfer apparatus than during the initialization of the OS, and making a request to set a transfer length shorter as the frequency of occurrence of the data transfer is higher, the transfer length indicating an amount of data transferred in one execution of the data transfer; and
instructing data transfer in which specific data is transferred from the peripheral device to the main storage device, at the time of activation of the data transfer apparatus, in accordance with the transfer length requested.

14. A non-transitory computer-readable medium storing a data transfer program that performs data transfer between a main storage device and a peripheral device, the data transfer program causing a computer to execute:
request processing to estimate that, at the time of activation of the data transfer apparatus, a frequency of occurrence of the data transfer is higher after initialization of an operating system (OS) of the data transfer apparatus than during the initialization of the OS, and make a request to set a transfer length shorter as the frequency of occurrence of the data transfer is higher, the transfer length indicating an amount of data transferred in one execution of the data transfer; and
transfer processing to instruct data transfer in which specific data is transferred from the peripheral device to the main storage device, at the time of activation of the data transfer apparatus, in accordance with the transfer length requested by the request processing.
